(19) United States
(12) Patent Application Publication
(10) Pub. No.: US 2020/0001837 A1
(43) Pub. Date: Jan. 2, 2020

(54) STANDSTILL SECURING CONCEPT FOR SECURING A STANDSTILL OF A VEHICLE

(71) Applicant: Dr. Ing. h.c. F. Porsche Aktiengesellschaft, Stuttgart (DE)

(72) Inventors: Donatus Neudeck, Stuttgart (DE); Daniel Weidner, Ludwigsburg (DE); Michael Bott, Korntal-Muenchingen (DE); Bernhard Schweizer, Eutingen-Rohrdorf (DE)

(73) Assignee: Dr. Ing. h.c. F. Porsche Aktiengesellschaft, Stuttgart (DE)

(21) Appl. No.: 16/447,234

(22) Filed: Jun. 20, 2019

(30) Foreign Application Priority Data
Jun. 28, 2018 (DE) 102018115685.5

(51) Int. Cl. B60T 1/00; F16H 63/48; B60T 1/06; F16H 63/34

(52) U.S. Cl. CPC B60T 1/005; F16H 63/3416; B60T 1/062; F16H 63/486

(57) ABSTRACT

A standstill securing concept for securing a standstill of a vehicle, having a transmission lock device for blocking a transmission movement of a drive transmission of the vehicle in a locking position and for enabling the transmission movement in an enablement position. The standstill securing concept further has a rotation-preventing securing device for blocking a wheel movement of one drive wheel of a drive axle of the vehicle in a park position and for enabling a wheel movement of the drive wheel in a drive position. An opposite drive wheel of the drive axle is configured without a device for rotation prevention.

### CROSS-REFERENCE TO RELATED APPLICATION

This application claims priority to German Patent application No. DE 10 2018 115 685.5, filed Jun. 28, 2018, which is incorporated by reference herein in its entirety.

### FIELD OF THE INVENTION

The present invention relates to a standstill securing system of a vehicle, and to a method for securing a standstill of a vehicle by means of such a securing system.

### BACKGROUND OF THE INVENTION

It is known that vehicles at a standstill should be secured against rolling away or sliding away in an undesired manner. In the case of classic vehicles, this is realized for example by means of the handbrake. The handbrake is in this case activated mechanically by means of a lever in the interior compartment of the vehicle or electromechanically, such that corresponding brake shoes or brake linings at the drive wheels, or even and non-driven wheels, of the vehicle can engage. In this engagement position, the known handbrake secures the vehicle against rolling away.

Furthermore, in most vehicles, there is the additional possibility of securing the drive train and thus the driven wheels against rotation for example by means of a positively engaging or else frictionally engaging principle, for example in the case of transmission locks in automatic transmissions.

A disadvantage of the known solutions is the high outlay in terms of construction, the high cost expenditure and the large space requirement of such standstill securing means. Whereas the mechanical handbrake has nowadays commonly been replaced by electromechanical solutions, these nevertheless still act on at least two wheels of an axle. This means that, even in the case of driven wheels and a possible rotation-preventing securing means of the drivetrain such as a transmission lock, a separate mechanical component of the parking brake system is arranged at each drive wheel of the vehicle in order to realize there the parking brake functionality for securing the vehicle against rolling away. Aside from the space requirement at each secured wheel, it is necessary for corresponding mechanical or electromechanical contact to be established. Not least, aside from a large structural space, the increased number of parking brake devices leads to an increased weight and increased costs in the vehicle.

### SUMMARY OF THE INVENTION

It would be desirable to secure the standstill of a vehicle in an inexpensive and simple manner.

Described herein is a standstill securing concept for securing a standstill of a vehicle, having a transmission lock device for blocking a transmission movement of a drive transmission of the vehicle in a locking position and for enabling the transmission movement in an enablement position, furthermore having a rotation-preventing securing means for blocking a wheel movement of one drive wheel of a drive axle of the vehicle in a park position and for enabling a wheel movement of said drive wheel in a drive position, wherein an opposite drive wheel of said drive axle is configured without a rotation-preventing securing means and to a method for securing a standstill of a vehicle by means of said standstill securing concept.

Further features and details of the invention will emerge from the dependent claims, the description and the drawings. Features and details which are described in conjunction with the standstill securing system according to aspects of the invention self-evidently also apply in conjunction with the method according to aspects of the invention and vice versa in each case, and therefore reference is or can be made constantly from one to the other in respect of the disclosure of the individual aspects of the invention.

According to aspects of the invention, a standstill securing system serves for securing a standstill of a vehicle. For this purpose, the standstill securing system has a transmission lock device for blocking a transmission movement of a drive transmission of the vehicle in a locking position and for enabling said transmission movement in an enablement position. Furthermore, the standstill securing system is equipped with a device for blocking a wheel movement of one wheel of an axle of the vehicle in a park position and for enabling said wheel movement of said wheel in a drive position. Here, an opposite wheel of said axle is configured without a device of said type.

A standstill securing system according to aspects of the invention combines two different blocking systems to form a common standstill securing system. One of these is a transmission lock device which is capable of preventing the internal transmission movement. During normal driving operation, the torque and thus also the rotation at the transmission input is provided by an engine driveshaft. Depending on the selection of different transmission ratios, that is to say the corresponding gear ratio selection at the drive transmission, individual gearwheels within the drive transmission perform a transmission movement, which is normally a rotational movement. Depending on the set or engaged gear ratio, it is then possible, at the output shaft of the drive transmission, for drive at the drive axle with a corresponding output speed correlating with the gear ratio to be ensured.

According to aspects of the invention, the transmission lock device is now capable of enabling or even blocking the transmission movement discussed above. If the vehicle is placed into a park mode and is at a standstill, it is commonly also the case that the drive engine is shut down. Thus, no torque and thus also no rotational movement will be present at the input shaft of the drive transmission, because nothing is provided by the drive engine. The drive transmission which is at a standstill may however be caused to perform an externally induced transmission movement by external influences, for example by the movement of the vehicle or the rotation of the drive axle. To prevent this, the transmission lock device may be moved from the enablement position into the locking position in order to prevent, in particular fully prevent, this internal transmission movement.

If an externally induced movement is now introduced, for example by an action of gravitational force on the vehicle and a rolling tendency of the vehicle, this would normally lead to the internal transmission movement being performed. Since the transmission lock device is however in the locking position, this internal transmission movement of the drive transmission is prevented, such that, here, a first braking action for securing the standstill of the vehicle is ensured.

To further increase the securing action in the standstill state of the vehicle, this transmission securing action is now combined, by means of the transmission lock device, with a device for rotation prevention of a wheel. This device for rotation prevention is arranged in the region of the drive wheel or of the drive axle and can, in the case of this one drive wheel, prevent a rotational movement or a wheel movement of the drive wheel. This may be realized for example by means of frictionally engaging and/or positively engaging designs of the rotation-preventing device, as will be discussed in more detail further below. If the rotation-preventing device is situated in the drive position, then a free wheel movement of the drive wheel and of the drive axle is possible. The rotational energy provided by the drive transmission can thus be converted by means of the drive axle into a rotation of the drive wheel, without this wheel movement in the drive position being impaired by the parking brake device. When the vehicle is at a standstill, when it is placed into a parking mode, the rotation-preventing device can then be switched from the drive position into the park position. In this park position, the wheel movement is prevented. Thus, if the vehicle is situated in this park mode, then it is likewise again possible for an externally induced movement of the drive wheel to be prevented. If the vehicle is for example standing on a slope and this slope gradient acts with the aid of gravitational force so as to roll the vehicle away from the park position, then this rolling-away movement can be ensured only by means of a wheel movement of the drive wheel also. By virtue of this wheel movement at this drive wheel being prevented by means of the rotation-preventing device in the park position, it is possible here in an effective manner to generate a standstill securing action, and rolling-away of the vehicle can be prevented.

As is evident from the paragraphs above, the present invention combines two separate securing systems. Here, one of these is a transmission-internal standstill securing means by way of the transmission lock device, and the other is an external standstill securing means by way of the rotation-preventing device at the at least one drive wheel.

This combination of two separate securing mechanisms then makes it possible to dispense with cumbersome and complex parking brake devices according to the prior art. In particular, this is evident from the fact that, at the same drive axle at which the parking brake device is arranged, the opposite drive wheel is configured without a parking brake device of said type. This is to be understood in particular to mean that the opposite drive wheel is configured without any parking brake device. In relation to the known solutions according to the prior art, it is possible here to dispense with at least one additional parking brake device at the opposite drive wheel. Through this alone, it is possible to achieve great advantages with regard to space requirement, costs and complexity. However, it is additionally also possible for the (positively engaging or frictionally engaging) rotation-preventing device that is used at the drive wheel to be secured to be of smaller, more lightweight and more compact design, because it in combination with the transmission lock device provides the desired standstill securing action by way of both wheels of the axle.

Advantages may be achieved if, in a standstill securing system according to aspects of the invention, the transmission lock device, in the locking position, assumes a position of low transmission ratio, in particular the position of lowest transmission ratio, of the drive transmission. A drive transmission of a vehicle is commonly equipped with various gear ratios and transmission ratios. The lowest transmission ratio is commonly referred to as the first gear ratio, and the correspondingly higher gear ratios correlate with correspondingly higher transmission ratios. It may also be the case that a low transmission ratio or the lowest transmission ratio is provided by a reverse gear ratio of the drive transmission. By virtue of the fact that the transmission lock device, in the locking position, correlates with a correspondingly low transmission ratio position of the drive transmission, the transmission lock device may be at least partially formed by the shift transmission of the drive transmission itself. This makes it possible to dispense with additional components for the transmission lock device, or to at least minimize the additional outlay for said transmission lock device. In this way, it is possible to be able to provide the transmission lock device with minimal outlay. The actuation is performed substantially as in the case of a normal shift process, that is to say for example through the engagement of the first gear ratio or of the reverse gear ratio. It is self-evidently basically also conceivable for a dedicated shift position in the drive transmission with minimal transmission ratio, or even with complete internal blockage of an internal transmission movement, to be provided as part of the gearshift gate or as part of an electromechanical process.

Further advantages are achieved if, in the case of a standstill securing system, each drive axle of the vehicle is equipped with a parking brake device for one drive wheel, wherein the opposite drive wheel of each drive axle is configured without a rotation-preventing securing means. Here, in particular, all of the rotation-preventing securing systems of the wheel are of identical or substantially identical form. Whereas it is basically the case that the core concept according to aspects of the invention of securing the standstill of the vehicle is achieved already when the transmission lock device is correlated with a single rotation-preventing securing means of the wheel, the combination of two or more rotation-preventing securing means of the wheel may provide advantages in the case of complex drives or in the case of large vehicles with multiple drive axles. This is the case in particular in all-wheel drive vehicles, or in vehicles with two or more drive axles in the case of three or more axles overall, for example in the case of heavy goods vehicles. It is however crucial that the advantage according to aspects of the invention is maintained in order to reduce the structural space and the complexity by virtue of in each case one drive wheel at each drive axle remaining free from such rotation-preventing securing means. The advantages according to aspects of the invention can thus be used even in the case of complex all-wheel drive vehicles or vehicles with multiple drive axles. By virtue of the fact that the individual rotation-preventing securing means are of identical or substantially identical form, the complexity remains low, because the same parts can be used substantially for all drive axles.

It is furthermore advantageous if, in a system according to aspects of the invention for securing the standstill of a vehicle, the rotation-preventing securing means is arranged between a drive wheel of the drive axle and a differential device of said drive axle. This rotation-preventing securing means is thus arranged no longer directly at the drive wheel but in the region of the drive axle within the vehicle. The design freedom in the region of the drive wheel is thus greatly increased. The differential device is to be understood to mean the facility for compensating different rotational speeds of the drive wheel and of the opposite drive wheel. By virtue of the fact that the rotation-preventing securing means is now capable of holding the one output of the differential device to the drive wheel fixed, and at the same time the transmission lock device holds the cage of the differential device fixed as viewed from the drive transmission, the functionality of a differential lock is provided, so to speak, in the combination of the transmission lock device and the rotation-preventing securing means of a wheel. This functionality of a virtual differential lock is configured in particular as a 100% differential lock, such that any relative movement between the drive wheel and the opposite drive wheel is prevented. This, too, is preferably implemented correspondingly at all drive axles.

It may likewise be advantageous if, in a system according to aspects of the invention for securing the standstill of a vehicle, the rotation-preventing securing means of a wheel is formed separately from a brake device of the vehicle for the driving operation. In order to bring a vehicle from a movement situation into a static situation or a situation at least with reduced speed, brake systems are normally provided which permit a deceleration of the vehicle. These may be in particular disk brakes or shoe-type brakes. However, in modern vehicles, recuperation systems and thus magnetic brake systems are also conceivable.

In particular, the rotation-preventing securing means of the wheel is formed preferably separately, in particular completely separately, from these regular brake systems. This makes it possible for each of the systems, that is to say the rotation-preventing securing means of a wheel on the one hand and the regular brake system on the other hand, for the required function to be configured in a specific manner. With regard to the rotation-preventing securing means of a wheel, this means that a simple and inexpensive design can be selected here.

Furthermore, increased arrangement freedom for the rotation-preventing securing means is possible in this way.

Further advantages are realized if, in a system according to aspects of the invention for securing the standstill of a vehicle, the rotation-preventing securing means of a wheel has a friction portion which, in the park position, is in frictionally engaging contact with a counterpart friction portion of the drive wheel and/or of the drive axle. Such frictional engagement of the friction surfaces makes it possible for the rotation-preventing securing means of a wheel to be provided easily and inexpensively. Here, position-free activation of the rotation-preventing securing means may be possible here, because no defined relative position between friction portion and counterpart friction portion is necessary in order to assume the park position. Also, particularly easy handling, for example by means of a hydraulic movement, is possible for the activation of the rotation-preventing securing means.

It is likewise conceivable that, in the case of a system according to aspects of the invention for securing the standstill of a vehicle, the rotation-preventing securing means has a pawl portion which, in the park position, engages in positively engaging fashion into a counterpart pawl portion of the drive wheel and/or of the drive axle. Such positively engaging securing may self-evidently also conceivably be combined with frictionally engaging securing according to the paragraph above. Since, for the engagement of the pawl portion into the counterpart pawl portion, a certain basic alignment is required between the rotation-preventing securing means and the drive wheel or the drive axle, the pawl portion and/or the counterpart pawl portion may have corresponding insertion bevels or guide aids in order to ensure this relative position and permit an easy transfer of the rotation-preventing securing means into the park position. By contrast to the frictionally engaging embodiment, positive engagement offers a substantially absolute securing action because slippage of a frictionally engaging action is no longer possible in the event of high forces being introduced.

The present invention likewise relates to a method for securing a standstill of a vehicle by means of a system according to aspects of the invention for securing the standstill of a vehicle, comprising the following steps:
bringing the vehicle to a standstill,
switching the transmission lock device into the locking position,
switching the rotation-preventing securing means into the park position.

A method according to aspects of the invention therefore affords the same advantages as have been explained in detail with regard to a system according to aspects of the invention for securing the standstill of a vehicle.

It may likewise be advantageous if, in a method according to aspects of the invention, the switching into the locking position and into the rotation-preventing securing means of a wheel is performed simultaneously or substantially simultaneously. This may be understood in particular to mean that, during this switching movement, the respective end position is reached jointly. However, joint starting of the switching process is basically also possible, if these require the same length of time or substantially the same length of time for the switching movement. In both cases, an unsecured intermediate state, in which only one of the two standstill securing functionalities is in the activated state, is prevented from arising.

It is likewise advantageous if, in a method according to aspects of the invention, the switching processes of the transmission lock device and of the rotation-preventing securing means of a wheel are triggered by an activation of a parking mode of the vehicle. This may for example be the activation of the shift position P at a transmission selector lever. An electromechanical changeover upon the activation of this park mode will in particular lead simultaneously to the two switching movements of the transmission lock device, on the one hand, and of the rotation-preventing securing means of a wheel, on the other hand. Here, a separate switch may self-evidently also be conceivable for the purposes of activating this parking mode and deactivating it again.

### BRIEF DESCRIPTION OF THE DRAWING

Further advantages, features and details of the invention emerge from the description below in which exemplary embodiments of the invention are described in detail with reference to the drawings. The features mentioned here in the claims and in the description may be essential to the invention in each case individually by themselves or in any desired combination.

Schematically in the drawings:

FIG. 1 shows a first embodiment of a system according to aspects of the invention for securing the standstill of a vehicle;

FIG. 2 shows a further embodiment of a system according to aspects of the invention for securing the standstill of a vehicle;

FIG. 3 shows a further embodiment of a system according to aspects of the invention for securing the standstill of a vehicle;

FIG. 4 shows a further embodiment of a system according to aspects of the invention for securing the standstill of a vehicle;

FIG. 5 shows a further embodiment of a system according to aspects of the invention for securing the standstill of a vehicle;

FIG. 6 shows an embodiment of a system for securing the standstill of a vehicle in a drive position with a frictionally engaging system;

FIG. 7 shows the embodiment of FIG. 6 in the park position;

FIG. 8 shows an embodiment of the system for securing the standstill of a vehicle in a drive position with a positively engaging configuration and

FIG. 9 shows the embodiment of FIG. 8 in the park position.

### DETAILED DESCRIPTION OF THE INVENTION

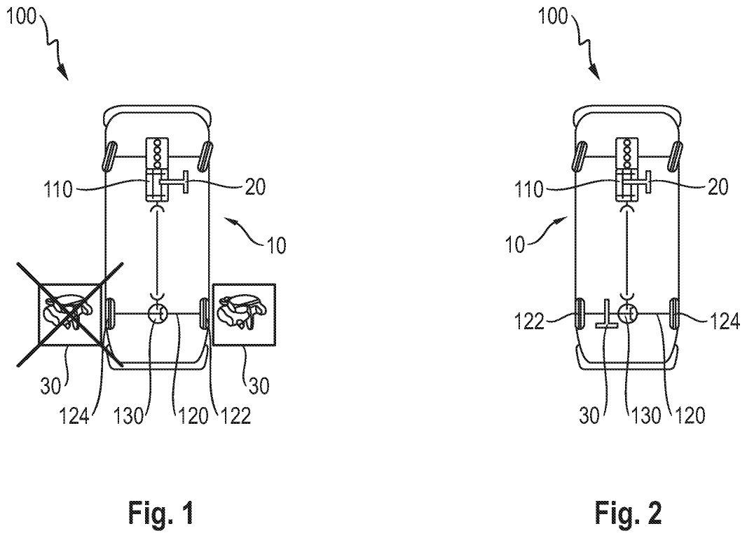

FIGS. 1 to 5 illustrate five different embodiments of a system 10 according to aspects of the invention for securing the standstill of a vehicle. Here, FIG. 1 is based explicitly on a solution that is basically known in the prior art. The embodiment of a drive axle 120 of the vehicle 100 with two separate rotation-prevention securing means 30 at each of the drive wheels 122, 124 is basically known from the prior art. However, in the manner according to aspects of the invention, it is the case in the embodiment of FIG. 1 that the rotation-preventing securing means of a wheel 30 is arranged exclusively at the drive wheel 122 of the drive axle 120, whereas, as illustrated by the dashed lines, no rotation-preventing securing means of a wheel 30 is arranged at the opposite drive wheel 124 of the drive axle 120. To nevertheless realize the desired standstill securing action, it is now the case, in addition to the known solutions, that a transmission lock device 20 is arranged at the drive transmission 110 in order, in this case, too, to ensure a locking function for securing the standstill of the vehicle 100.

FIG. 2 illustrates an alternative embodiment in relation to FIG. 1. Thus, here, the rotation-preventing securing means of a wheel 30 is not assigned directly to a drive wheel 122, but is rather arranged in the drive axle 120 between a differential device 130 and the drive wheel 122. In this case, too, the opposite drive wheel 124 again remains free from a rotation-preventing securing means 30. By virtue of the fact that the transmission lock device 20 now locks the input of the differential device 130 and, at the same time, one of the outputs of the differential devices 130 is locked by means of the rotation-preventing securing means 30, the combination of transmission lock device 20 and rotation-preventing securing means 30 can also be understood as a virtual differential lock, which in particular has a mode of operation of a locking function of up to 100%.

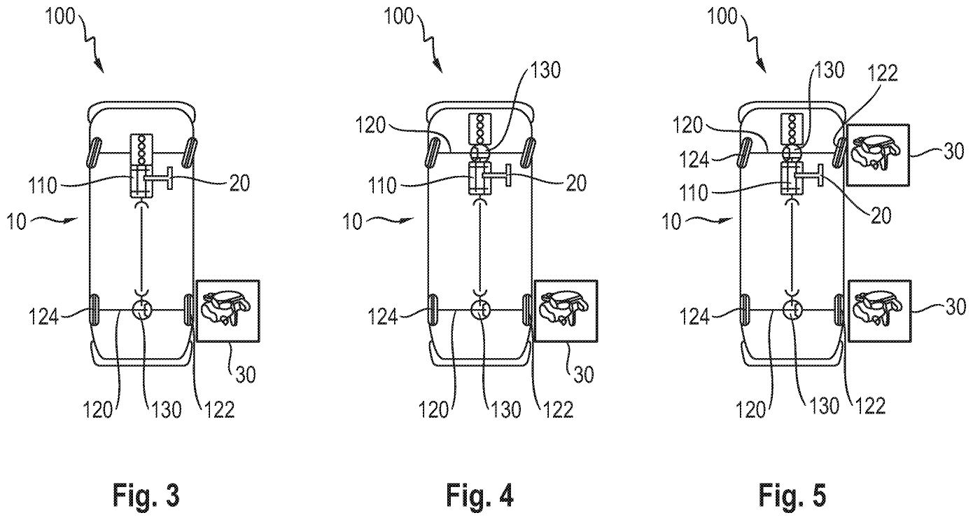

FIG. 3 shows a solution as already illustrated as a result in FIG. 1, but now without the old rotation-preventing securing means 30, illustrated by dashed lines in FIG. 1, at the opposite drive wheel 124. In this case, too, a combination with a differential device 130 is illustrated. FIG. 4 shows a solution with an all-wheel drive system. This means that, here, not only the rear axle but also the front axle is configured as a drive axle 120. Here, a differential device 30 is also arranged at the front axle. For a secured standstill, it is however basically sufficient if, even in the case of an all-wheel drive system, only one drive axle 120, in this case the rear-wheel axle, is equipped with the rotation-preventing securing means 30, as long as the transmission lock device 20 centrally at the drive transmission 110 ensures the corresponding additional securing action.

FIG. 5 shows an additional securing action in the case of a vehicle 100 equipped with all-wheel drive, such that, proceeding from the solution of FIG. 4, a rotation-preventing securing means 30 is now also arranged at the drive wheel 122 at the front drive axle 120. In this case, too, the opposite drive wheel 124 at the front axle remains free from a rotation-preventing securing means 30. Here, it must also be pointed out that the mode of operation is self-evidently independent of whether the rotation-preventing securing means 30 are all arranged on the same side of the vehicle 100 or on different sides of the vehicle.

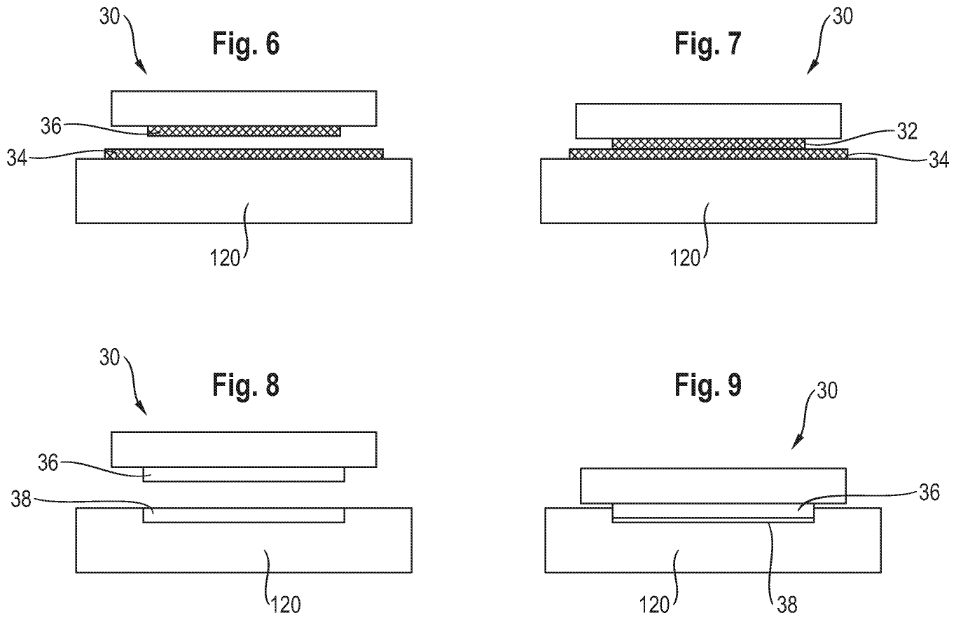

FIGS. 6 and 7 show one possibility for the design of the rotation-preventing securing means 30.

Here, a frictionally engaging embodiment is illustrated, such that, in FIG. 6, in the enablement position, there is no contact between a friction portion 32 and a counterpart friction portion 34. If, in the park position, a movement of the rotation-preventing securing means 30 toward the drive axle 120 is performed, then the friction portion 32 and the counterpart friction portion 34 entered into frictionally engaging contact with one another, which provides the desired securing functionality against a wheel movement of the drive wheel 122.

With the same mode of operation but different function, FIGS. 8 and 9 show an embodiment of the rotation-preventing securing means 30. In order, here, to prevent a wheel movement of the drive wheel 122 in the park position as per FIG. 9, the rotation-preventing securing means 30 is configured with a pawl portion 36, which engages into a counterpart pawl portion 38 of the drive axle 120. In the park position as per FIG. 8, these two portions are not in engagement, such that a free wheel movement of the drive wheel 122 is made possible.

The above explanation of the embodiments describes the present invention exclusively within the scope of examples. Individual features of the embodiments may self-evidently be freely combined with one another, if technically expedient, without departing from the scope of the present invention.

What is claimed is:

1. A standstill securing apparatus for securing a standstill of a vehicle, comprising:
a transmission lock device for blocking a transmission movement of a drive transmission of the vehicle in a locking position and for enabling the transmission movement in an enablement position, and
a rotation-preventing securing means configured for blocking a wheel movement of one drive wheel of a drive axle of the vehicle in a park position and for enabling a wheel movement of said drive wheel in a drive position,
wherein an opposite drive wheel of said drive axle is configured without a rotation-preventing securing means.

2. The standstill securing apparatus as claimed in claim 1, wherein the transmission lock device, in the locking position, assumes either a lower or a lowest transmission ratio position of the drive transmission.

3. The standstill securing apparatus as claimed in claim 1, wherein each drive axle of the vehicle is configured with a rotation-preventing securing means for one drive wheel, wherein the opposite drive wheel of each drive axle is configured without a rotation-preventing securing means, wherein all of the rotation-preventing securing means are of either identical or substantially identical form.

4. The standstill securing apparatus as claimed in claim 1, wherein the rotation-preventing securing means is arranged between a drive wheel of the drive axle and a differential device of said drive axle.

5. The standstill securing apparatus as claimed in claim 1, wherein the rotation-preventing securing means is formed separately from a brake device of the vehicle for driving operation.

6. The standstill securing apparatus as claimed in claim 1, wherein the rotation-preventing securing means has a friction portion which, in the park position, is in frictionally engaging contact with a counterpart friction portion of at least one of (i) the drive wheel and (ii) the drive axle.

7. The standstill securing apparatus as claimed in claim 1, wherein the rotation-preventing securing means has a pawl portion which, in the park position, engages in positively engaging fashion into a counterpart pawl portion of the at least one of (i) the drive wheel and (ii) the drive axle.

8. A method for securing a standstill of a vehicle using a standstill securing apparatus including (i) a transmission lock device for blocking a transmission movement of a drive transmission of the vehicle in a locking position and for enabling the transmission movement in an enablement position, and (ii) a rotation-preventing securing means configured for blocking a wheel movement of one drive wheel of a drive axle of the vehicle in a park position and for enabling a wheel movement of said drive wheel in a drive position, wherein an opposite drive wheel of said drive axle is configured without a rotation-preventing securing means, said method comprising:
bringing the vehicle to a standstill,
switching the transmission lock device into the locking position, and
switching the rotation-preventing securing means into the park position.

9. The method as claimed in claim 8, wherein the switching steps are performed either simultaneously or substantially simultaneously.

10. The method as claimed in claim 8, wherein the switching of the transmission lock device and of the rotation-preventing securing means are triggered by an activation of a park mode of the vehicle.
